(19) United States
(12) Patent Application Publication
(10) Pub. No.: US 2010/0069570 A1
(43) Pub. Date: Mar. 18, 2010

(54) Functionalization of Polymers

(76) Inventor: Nicolay Vasilev Tsarevsky, Pittsburgh, PA (US)

Correspondence Address: Nicolay Vasilev Tsarevsky;Apt 3, 5628 Forbes Ave., Pittsburgh, PA, 15217, US

(21) Appl. No.: 12/462,237

(22) Filed: Jul. 31, 2009

Related U.S. Application Data
(60) Provisional application No. 61/089,646, filed on Sep. 18, 2008.

(51) Int. Cl. C08F 8/30

(52) U.S. Cl. 525/50

(57) ABSTRACT

The invention describes a method for functionalization of polymers (introduction of a functional group Z) using a combination of hypervalent iodine (III) compounds (such as (diacetoxyiodo)benzene, PhI(OAc)₂) with a trialkylsilyl compound R₃SiZ or salts like NaZ. The reaction is carried out at mild conditions and can be used for efficient modification of polymers in solution or polymer surfaces. For example, the reaction of polystyrene or poly(4-vinylpyridine) with PhI(OAc)₂ and Me₃SiN₃ yields azidated polymers. The products of the reaction could be further modified by copper-catalyzed click chemistry with an alkyne-terminated poly(ethylene oxide), leading to polymeric brushes with a hydrophobic backbone and a moderate density of hydrophilic side chains.

This application is based on, and incorporates, provisional application 61/089,646 filed Aug. 18, 2008.

### TECHNICAL FIELD OF THE INVENTION

Post-polymerization of functionalization of polymers is a viable route to prepare functional materials, particularly when (co)polymerization of a monomer comprising the desired functional group is not commercially available and/or does not form the desired copolymer in a copolymerization reaction. Herein several high yield functionalization procedures are applied to direct functionalization of (co)polymers and material surfaces.

### BACKGROUND

Post-polymerization functionalization of a polymer is an applicable approach to prepare polymers with desired properties or to modify the surface of a polymeric particle, a fabricated polymeric article or a solid substrate such as the surface of a metal. There are two types of functional polymers; polymers with pendant functional groups and polymers with terminal functional groups. Since the development of “living”/controlled polymerization procedures frequently the post-polymerization functionalization reactions are concerned with modifying the terminal functional group of a polymer chain in order to prepare a material for further chain extension reactions, such as formation of polyurethanes, or to attach a moiety with a desired functional group, such as a peptide or a drug, to a polymer. There has been a long term interest in synthesizing telechelic polymers by ionic mechanisms but recent interest has increasingly focused on living or controlled radical polymerization processes such as nitroxide mediated polymerization (NMP), atom transfer radical polymerization (ATRP) and reversible addition fragmentation transfer (RAFT) procedures since in addition to forming telechelic polymers they can (co)polymerize polar functional monomer units and directly incorporate functionality into the backbone of the polymer.

Progress in the different CRP procedures has been reported in several review articles, (ATRP) [See Matyjaszewski, K. ACS Symp. Ser. 1998, 685, 258-283; Matyjaszewski, K. ACS Symp. Ser. 2000, 768, 2-26; Qiu, J.; Charleux, B.; Matyjaszewski, K. Prog. Polym. Sci. 2001, 26, 2083-2134; Davis, K. A.; Matyjaszewski, K. Advances in Polymer Science 2002, 159, 2-166] nitroxide mediated polymerization (NMP), [See Hawker, C. J.; Bosman, A. W.; Harth, E. Chem. Rev. 2001, 101, 3661-3688] reversible addition fragmentation chain transfer (RAFT) [See Chiefari, J.; Chong, Y. K.; Ercole, F.; Krstina, J.; Jeffery, J.; Le, T. P. T.; Mayadunne, R. T. A.; Meijs, G. F.; Moad, C. L.; Moad, G.; Rizzardo, E.; Thang, S. H. Macromolecules 1998, 31, 5559-5562;Chiefari, J.; Rizzardo, E. In Handbook of Radical Polymerization; Matyjaszewski, K.; Davis, T. P., Eds.; Wiley-Interscience: Hoboken, 2002; pp 629-690; Moad, G.; Rizzardo, E.; Thang, S. H. Australian Journal of Chemistry 2005, 58, 379-410] and catalytic chain transfer (CCT). [See Gridnev, A. A.; Ittel, S. D. Chemical Reviews 2001, 101, 3611-3659]

Polymers with pendant functionality are generally obtained by (co)polymerization of a monomer containing the desired functional group, or by (co)polymerization of a monomer with a protected functional group or a functional group that can be converted into the desired group in a post-polymerization reaction. In the majority of these post-polymerization transformation reactions the process of linking the ultimate desired functional group to the polymer backbone involves thermally or hydrolytically unstable linking groups.

In patent application WO/05087818, which is herby incorporated by reference, a number of high yield “click” chemistry procedures were discussed. Among them one of the more frequently applied procedures is the copper I catalyzed Huisgen 1,3-dipolar cycloaddition reaction. [Huisgen, R. Proc. Chem. Soc. 1961, 357. Kolb, H. C.; Finn, M. G.; Sharpless, K. B. Angew. Chem. Int. Ed. 2001, 40, 2004; Rostovtsev, V. V.; Green, L. G.; Fokin, V. V.; Sharpless, K. B. Angew. Chem. Int. Ed. 2002, 41, 2596] All click chemistry reactions discussed by Sharpless are highly selective, high yield reactions that may be used for post-polymerization functionalization and chain extension chemistry as exemplified herein. Some further examples of reactions which are known to proceed in a highly selective, high yield manner, and should not interfere one with another, or at least the products of these reactions should not interfere with the reagents used for another reaction, include, but are not limited to, a hydrosilation reaction of H—Si and simple non-activated vinyl compounds, urethane formation from alcohols and isocyanates, 2+3 cycloaddition of alkyl azides and acetylenes, Menshutkin reaction of tertiary amines with alkyl iodides or alkyl trifluoromethanesulfonates, Michael additions e.g. the very efficient maleimide-thiol reaction, atom transfer radical addition (ATRA) reactions between alkyl halides and an olefin (R¹,R²—C═C—R³,R⁴), metathesis, Staudinger reaction of phosphines with alkyl azides, oxidative coupling of thiols, many of the procedures already used in dendrimer synthesis, especially in a convergent approach, which require high selectivity and rates.

Therefore, attached functionality may be chosen from acetylene bond, an azido-group, a nitrile group, acetylenic, amino group, phosphino group. For example the click chemistry reaction where copolymers with pendant nitrile groups were converted into tetrazole units by reaction with sodium azide, [WO 2005087818] can be modified and result in the addition of a functional group selected from amino, primary amino, hydroxyl, sulfonate, benzotriazole, bromide, chloride, chloroformate, trimethylsilane, phosphonium bromide or bio-responsive functional group including polypeptides, proteins and nucleic acids to the polymer.

In the definition of a suitable olefin for both ATRA and ATRP reactions, R¹,R²—C═C—R³,R⁴, R¹ and R² are independently selected from the group consisting of H, halogen, CN, CF₃, straight or branched alkyl of from 1 to 20 carbon atoms (preferably from 1 to 6 carbon atoms, more preferably from 1 to 4 carbon atoms), α,β-unsaturated straight or branched alkenyl or alkynyl of 2 to 10 carbon atoms (preferably from 2 to 6 carbon atoms, more preferably from 2 to 4 carbon atoms), α,β-unsaturated straight or branched alkenyl of 2 to 6 carbon atoms (preferably vinyl) substituted (preferably at the α-position) with a halogen (preferably chlorine), C₃-C₈ cycloalkyl, hetercyclyl, C(═Y)R⁵, C(═Y)NR⁶R⁷ and YC(═Y)R⁸, where Y may be NR⁸ or O (preferably O), R⁵ is alkyl of from 1 to 20 carbon atoms, alkoxy of from 1 to 20 carbon atoms, aryloxy or heterocyclyloxy, R⁶ and R⁷ are independently H or alkyl of from 1 to 20 carbon atoms, or R⁶ and R⁷ may be joined together to form an alkylene group of from 2 to 5 carbon atoms, thus forming a 3- to 6-membered ring, and R⁸ is H, straight or branched C₁-C₂₀ alkyl or aryl; and R³ and R⁴ are independently selected from the group consisting of H, halogen (preferably fluorine or chlorine), C₁-C₆ (preferably C₁) alkyl and COOR⁹ (where R⁹ is H, an alkali metal, or a C₁-C₆ alkyl group); or R¹ and R³ may be joined to form a group of the formula (CH2)_{n′} (which may be substituted with from 1 to 2n′ halogen atoms or C₁-C₄ alkyl groups) or C(═O)—Y—C(═O), where n′ is from 2 to 6 (preferably 3 or 4) and Y is as defined above; and at least two of R¹, R², R³ and R⁴ are H or halogen.

In the context of the present application, the terms “alkyl”, “alkenyl” and “alkynyl” refer to straight-chain or branched groups (except for C₁ and C₂ groups). Furthermore, in the present application, “aryl” refers to phenyl, naphthyl, phenanthryl, phenalenyl, anthracenyl, triphenylenyl, fluoranthenyl, pyrenyl, pentacenyl, chrysenyl, naphthacenyl, hexaphenyl, picenyl and perylenyl (preferably phenyl and naphthyl), in which each hydrogen atom may be replaced with alkyl of from 1 to 20 carbon atoms (preferably from 1 to 6 carbon atoms and more preferably methyl), alkyl of from 1 to 20 carbon atoms (preferably from 1 to 6 carbon atoms and more preferably methyl) in which each of the hydrogen atoms is independently replaced by a halide (preferably a fluoride or a chloride), alkenyl of from 2 to 20 carbon atoms, alkynyl of from 1 to 20 carbon atoms, alkoxy of from 1 to 6 carbon atoms, alkylthio of from 1 to 6 carbon atoms, C₃-C₈ cycloalkyl, phenyl, halogen, NH₂, C₁-C₆-alkylamino, C₁-C₆-dialkylamino, and phenyl which may be substituted with from 1 to 5 halogen atoms and/or C₁-C₄ alkyl groups. (This definition of “aryl” also applies to the aryl groups in “aryloxy” and “aralkyl.”) Thus, phenyl may be substituted from 1 to 5 times and naphthyl may be substituted from 1 to 7 times (preferably, any aryl group, if substituted, is substituted from 1 to 3 times) with one of the above substituents. More preferably, “aryl” refers to phenyl, naphthyl, phenyl substituted from 1 to 5 times with fluorine or chlorine, and phenyl substituted from 1 to 3 times with a substituent selected from the group consisting of alkyl of from 1 to 6 carbon atoms, alkoxy of from 1 to 4 carbon atoms and phenyl. Most preferably, “aryl” refers to phenyl, tolyl and methoxyphenyl.

In the context of the present invention, “heterocyclyl” refers to pyridyl, furyl, pyrrolyl, thienyl, imidazolyl, pyrazolyl, pyrazinyl, pyrimidinyl, pyridazinyl, pyranyl, indolyl, isoindolyl, indazolyl, benzofuryl, isobenzofuryl, benzothienyl, isobenzothienyl, chromenyl, xanthenyl, purinyl, pteridinyl, quinolyl, isoquinolyl, phthalazinyl, quinazolinyl, quinoxalinyl, naphthyridinyl, phenoxathiinyl, carbazolyl, cinnolinyl, phenanthridinyl, acridinyl, 1,10-phenanthrolinyl, phenazinyl, phenoxazinyl, phenothiazinyl, oxazolyl, thiazolyl, isoxazolyl, isothiazolyl, and hydrogenated forms thereof known to those in the art. Preferred heterocyclyl groups include pyridyl, furyl, pyrrolyl, thienyl, imidazolyl, pyrazolyl, pyrazinyl, pyrimidinyl, pyridazinyl, pyranyl and indolyl, the most preferred heterocyclyl group being pyridyl. Accordingly, suitable vinyl heterocycles to be used as a monomer in the present invention include 2-vinyl pyridine, 6-vinyl pyridine, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxazole, 3-vinyl isothiazoles, 2-vinyl pyrimidine, 4-vinyl pyrimidine, 6-vinyl pyrimidine, and any vinyl pyrazine, the most preferred being 2-vinyl pyridine. The vinyl heterocycles mentioned above may bear one or more (preferably 1 or 2) C₁-C₆ alkyl or alkoxy groups, cyano groups, ester groups or halogen atoms, either on the vinyl group or the heterocyclyl group, but preferably on the heterocyclyl group. Further, those vinyl heterocycles which, when unsubstituted, contain an N—H group may be protected at that position with a conventional blocking or protecting group, such as a C₁-C₆ alkyl group, a tris-C₁-C₆ alkylsilyl group, an acyl group of the formula R¹⁰CO (where R¹⁰ is alkyl of from 1 to 20 carbon atoms, in which each of the hydrogen atoms may be independently replaced by halide [preferably fluoride or chloride]), alkenyl of from 2 to 20 carbon atoms (preferably vinyl), alkynyl of from 2 to 10 carbon atoms (preferably acetylenyl), phenyl which may be substituted with from 1 to 5 halogen atoms or alkyl groups of from 1 to 4 carbon atoms, or aralkyl (aryl-substituted alkyl, in which the aryl group is phenyl or substituted phenyl and the alkyl group is from 1 to 6 carbon atoms), etc. (This definition of “heterocyclyl” also applies to the heterocyclyl groups in “heterocyclyloxy” and “heterocyclic ring.”)

More specifically, preferred monomers include (meth)acrylate esters of C₁-C₂₀ alcohols, acrylonitrile, cyanoacrylate esters of C₁-C₂₀ alcohols, didehydromalonate diesters of C₁-C₆ alcohols, vinyl pyridines, vinyl N-C₁-C₆-alkylpyrroles, vinyl oxazoles, vinyl thiazoles, vinyl pyrimidines and vinyl imidazoles, vinyl ketones in which the α-carbon atom of the alkyl group does not bear a hydrogen atom (e.g., vinyl C₁-C₆-alkyl ketones in which both α-hydrogens are replaced with C₁-C₄ alkyl, halogen, etc., or a vinyl phenyl ketone in which the phenyl may be substituted with from 1 to 5 C₁-C₆-alkyl groups and/or halogen atoms), and styrenes which may bear a C₁-C₆-alkyl group on the vinyl moiety (preferably at the α-carbon atom) and from 1 to 5 (preferably from 1 to 3) substituents on the phenyl ring selected from the group consisting of C₁-C₆-alkyl, C₁-C₆-alkenyl (preferably vinyl), C₁-C₆-alkynyl (preferably acetylenyl), C₁-C₆-alkoxy, halogen, nitro, carboxy, C₁-C₆-alkoxycarbonyl, hydroxy protected with a C₁-C₆ acyl, cyano and phenyl. The most preferred monomers are methyl acrylate, methyl methacrylate, butyl acrylate, 2-ethylhexyl acrylate, acrylonitrile, styrene and substituted derivatives thereof.

To facilitate direct functionalization via azide-alkyne coupling, an acetylene- or azido-containing monomer can be polymerized, and the resulting polymer can be reacted with a compound containing the appropriate complementary functionality. However, as noted by the present inventor, [Sumerlin, B. S.; Tsarevsky, N. V.; Louche, G.; Lee, R. Y.; Matyjaszewski, K. Macromolecules 2005, 38, 7540-7545] ATRP of propargyl methacrylate did not provide a polymer with the desired level of control over the structure of the polymer and the reverse approach: polymerization of 3-azidopropyl methacrylate, a monomer with the desired functional group, requires synthesis of the monomer and, furthermore, the monomer is thermally unstable and becomes shock-sensitive at elevated temperatures, which makes it inconvenient for commercial use on a large scale.

As shown in Scheme 1 of the referenced paper the first azido functional group and any subsequent functional units incorporated by selective “click” linked functional groups are tethered to the polymer backbone through an ester group, [Kolb, H. C.; Finn, M. G.; Sharpless, K. B. Angew. Chem., Int. Ed. 2001, 40, 2004-2021] which is hydrolytically unstable and can be cleaved under acidic or basic conditions.

It is desirable to be able to attach azide groups via non-hydrolizable bonds and in one embodiment of the present invention procedures for attachment of an azide group directly through stable carbon bonds is disclosed.

Another approach to incorporate azide functionality into a polymer is accomplished by the reaction of an incorporated functional group with sodium azide. Polymers with terminal azide groups were formed by the reaction of the terminal halide in a polymer prepared by ATRP [Coessens, V.; Matyjaszewski, K. J. Macromol. Sci., Pure Appl. Chem. 1999, A36, 667-679] with sodium azide which can then be employed to attach additional desired functional groups such as a protein transduction domain. [Lutz, J.-F.; Boerner, H. G.; Weichenhan, K. Australian Journal of Chemistry 2007, 60, 410-413] The post-polymerization end-group transformation approach, however, yields polymers with only one (or limited: equal to the number of active chain ends) functionality.

Pendant epoxides can be efficiently opened with sodium azide in the presence of ammonium chloride in N,N-dimethylformamide (DMF) in one click-type reaction which leads to the formation of the corresponding 1-hydroxy-2-azido compounds suitable for a second click functionalization reaction. [Tsarevsky, N. V.; Bencherif, S. A.; Matyjaszewski, K. Macromolecules 2007, 40, 4439-4445] Reactions involving sodium azide are nuclophilic reactions and require a suitable inherently reactive functional group to be present on the first copolymer. However, as noted above, the azide functionality in the mentioned polymers was still attached via ester groups to the backbone.

Therefore there remains a need for development of a robust broadly applicable procedure to conduct azidation reactions on inherently stable precursor polymers, on the surfaces of fabricated polymeric materials, including but not limited to crosslinked polystyrene beads.

Polymers with multiple azide groups are useful not only in azide-alkyne click-type functionalization reactions but also can be used as radical/nitrene precursors through thermal or photo-stimulation. The obtained functional/reactive copolymers can react and be attached chemically to surfaces that react with radicals or nitrenes, for instance those with unsaturation. In this manner polymer surfaces can be photo-patterned or a polymeric film with desired properties can be attached to a substrate.

Azides are easily reduced to amines and the amine functional polymers can be applied in the synthesis of polyureas upon reaction with isocyanates optionally forming graft copolymers with biocompatible grafts such as poly(ethylene glycol) (PEG).

In the present application we disclose how to attach this desired versatile functionality to polymer backbones or surfaces through stable linking groups.

### DESCRIPTION OF INVENTION

It must be noted that, as used in this specification and the appended claims, the singular forms “a,” “and,” and “the” include plural referents unless the context clearly dictates otherwise. Thus, for example, reference to “a polymer” may include more than one polymer.

Unless otherwise indicated, all numbers expressing quantities of ingredients, time, temperatures, and so forth used in the present specification and claims are to be understood as being modified in all instances by the term “about.” Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, may inherently contain certain errors necessarily resulting from the standard deviation found in the respective testing measurements.

It is to be understood that this invention is not limited to specific compositions, components or process steps disclosed herein, as such may vary. It is also to be understood that the terminology used herein is for the purpose of describing particular embodiments only, and is not intended to be limiting.

### BRIEF DESCRIPTION OF THE DRAWINGS

The features and advantages of the present invention may be better understood, but are not limited, by reference to the accompanying figures, in which:

FIG. 1. IR spectra of films of polySty prepared by conventional radical polymerization (a) and the product of its azidation (b).

FIG. 2. GPC traces of a mixture of azidated polySty and alkyne-terminated PEO (bottom) and of the product (graft copolymer) of their Cu-catalyzed click reaction.

FIG. 3. IR spectrum (nujol mull, NaCl salt plates) of lower molecular weight azidated polystyrene prepared by ATRP.

FIG. 4. Size exclusion chromatography (SEC) traces of a mixture of lower molecular weight azidated polySty and poly(ethylene oxide) monomethyl ether pentynoate (MePEO-P) (2:5 by weight; bottom) and of the same mixture reacted for 16 h in the presence of CuBr (top).

FIG. 5. IR spectrum (film from methanol solution, NaCl salt plates) of azidated poly(4-vinylpyridine).

In small molecule organic chemistry it has been determined that hypervalent iodine (III) compounds containing one or two azide groups directly attached to the iodine atom, such as 1 or 2, L=N₃, can react with a variety of organic molecules yielding azidated compounds. [Zhdankin, V. V.; Stang, P. J. Chem. Rev. 1996, 96, 1123-1178; Chem. Rev. 2002, 102, 2523-2584.]

Examples include the azidation of aromatic aldehydes, [Chen, D. J.; Chen, Z. C. Tetrahedron Lett. 2000, 41, 7361-736] cyclic thioethers, [Tohma, H.; Egi, M.; Ohtsubo, M.; Watanabe, H.; Takizawa, S.; Kita, Y. Chem. Commun. 1998, 173-174] substituted anisoles, [Kita, Y.; et al, Tetrahedron Lett. 1991, 32, 4321-4324; Synlett 1994, 427-428] buckminsterfullerene, [Zhdankin, et al.; Mendeleev Commun. 2001, 51-52] and hydrocarbons such as adamantane and isooctane [Zhdankin, V. V. et al.; Synlett 1995, 1081-1082; J. Am. Chem. Soc. 1996, 118, 5192-5197] (Scheme 1).

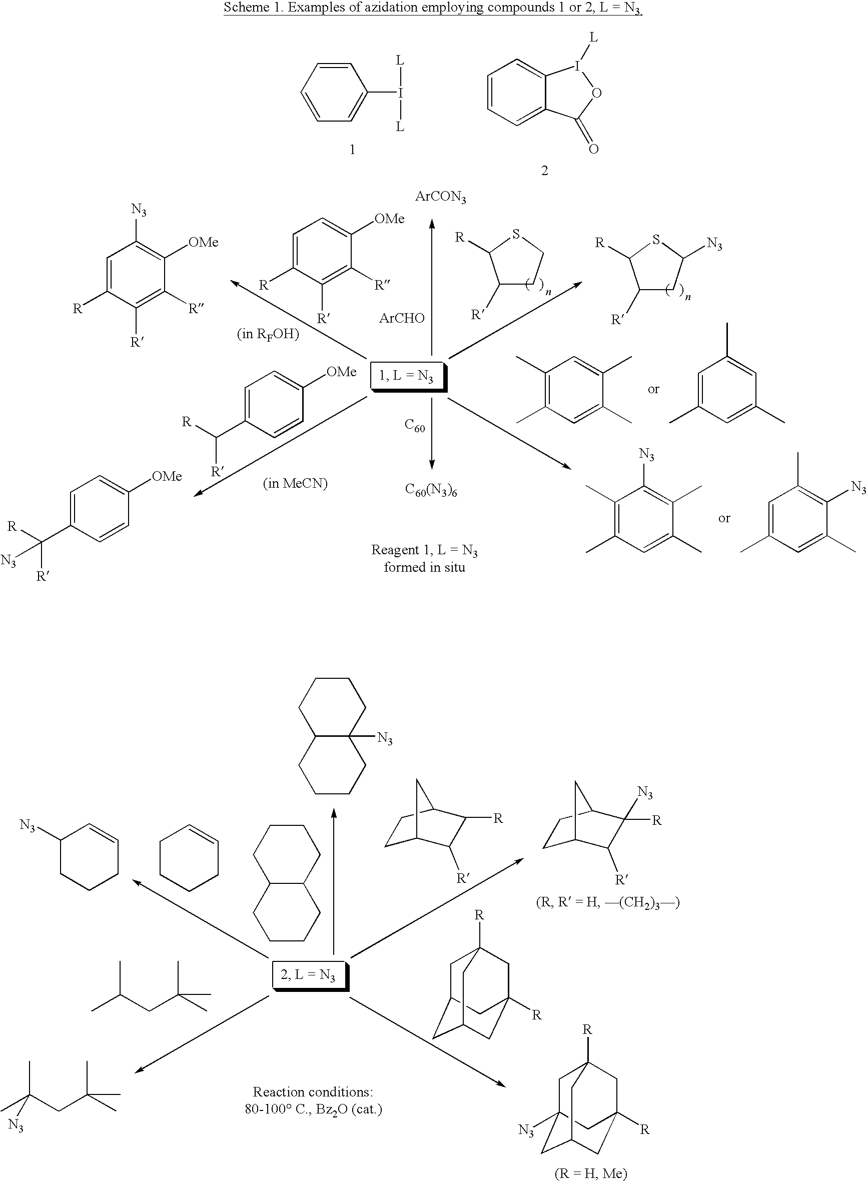

Compound 1, L=N₃, is unstable and is generated in situ via the reaction of the corresponding diacetoxy- or bis(trifluoroacetoxy)-derivative (1, L=AcO or CF₃CO₂, respectively) or iodosylbenzene PhIO with trimethylsilyl azide (TMSN₃) or NaN₃.

The benziodoxole 2, L=N₃, is markedly more stable and has been synthesized and isolated in pure form from the reaction of 2-iodosylbenzoic acid (2, L=OH) and TMSN₃. [Zhdankin, V. V.; et al.; J. Am. Chem. Soc. 1996, 118, 5192-5197.] Due to the higher stability of 2, L=N₃, the azidation reaction can be conducted at high temperatures (100-120° C.), which expands the utility of this transformation to a large number of substrates, including not very reactive ones. The azidations of organic substrates with 2, L=N₃ are carried out in the presence of small amounts of dibenzoyl peroxide. The mechanism of the reactions is thought to be radical, involving the highly reactive azide radical.

If it was indeed a radical process we envisioned that any radically abstractable atom on a polymer or on a polymeric surface could be replaced by an azide group and that the attached azide group could be used directly in reactions involving an azide functionality, such as “click” type linking chemistry, or the first attached azide group(s) can be converted into another functionality, including but not limited to primary and secondary amines, alcohols, Schiff bases and derivatives thereafter.

Confirmation of this novel concept is provided below.

In another embodiment of the invention the reaction of polymer functionalization by azidation can also be conducted on solid polymeric surfaces.

In a further embodiment an azido-functionalized polymer can be deposited on a substrate and the azido-functionality activated to tether the first polymer to the substrate. This embodiment can be extended to sprayable coatings where a film can be deposited on a substrate then the film tethered to the first surface thereby modifying the surface properties. This can be extended to include photolithography where stable linked insulating films are formed.

In a further embodiment the azido-group in the first functionalazed copolymer can be converted to another functional group and the formed functional polymer can be deposited on a substrate and the second functionality tether the polymer to the substrate.

Derivatives of compounds 1 and 2, wherein L=−CN, −SCN, −NHR would also functionalize targeted polymers or polymeric substrates. These materials can be formed by in situ formation of said compound 1 or 2, by reaction with the appropriate trimethylsilyl derivative, or by reactions of compounds 1 or 2 with L=Cl with the corresponding silver compound, for instance AgSCN or a potassium or sodium salt, such as NaSCN via a Finkelstein-type substitution.

It was envisioned that modifications of this small molecule chemistry could be applied to copolymers and that radically abstractable atom on a polymer or on a polymeric surface could be replaced by an azide group and that the attached azide group can be used directly in reactions involving an azide functionality, such as “click” chemistry or the first attached azide group(s) can be converted into another functionality, including but not limited to primary and secondary amines, alcohols, Schiff bases and derivatives thereafter.

In the initial exemplifying reaction in the following experimental section the reaction of polystyrene with a combination of (diacetoxyiodo)benzene and trimethylsilyl azide led to azidated polystyrenes. The reaction was conducted at relatively mild conditions (0° C. for 2-4 hours followed by heating to 50° C. for 2 hours). In contrast to the majority of reported azide-containing polymers, where the azide groups are often attached to the macromolecule via spacer containing a hydrolysable/degradable link (e.g., an ester group), the reaction reported here yielded functional macromolecules, in which the azide groups are more permanently attached to the polymer through carbon-carbon bonds.

In the initial example, the azidation of polystyrene, the amount of azide groups in the products could be estimated by IR spectroscopy and elemental analysis and, depending on the reaction conditions, roughly 1 in every 11 styrene units could be azidated, using non-optimized conditions. The polymers with azide groups were further used in a copper-catalyzed click-type grafting onto reaction using poly(ethylene oxide) monomethyl ether pentynoate as the functional alkyne. This reaction yielded polymeric brushes with a hydrophobic backbone and a moderate density of hydrophilic side chains.

### EXAMPLES AND DISCUSSION OF EXPERIMENTAL RESULTS

### Materials

Abreviations
PhI(OAc)₂
TMS-N₃
THF

PhI(OAc)₂ was synthesized from (dichloroiodo)benzene PhICl₂ and acetic acid in pyridine, as described in the literature. [Karele, B.; Neilands, O. Latv. PSR Zinatnu Akad. Vest., Kim. Ser. 1970, 587-590.] It was recrystallized from 5 M acetic acid (AcOH). Poly(ethylene oxide) monomethyl ether pentynoate (MePEO-P, Mₙ=2,000 g/mol) was synthesized by esterification of the polymeric alcohol with pentynoic acid. [Tsarevsky, N. V.; Bencherif, S. A.; Matyaszewski, K. Macromolecules 2007, 40, 4439-4445.] Polystyrene (Mₙ=1,600 g/mol, M_{w}/Mₙ=1.1) was prepared by ARGET ATRP. [Jakubowski, W.; Min, K.; Matyjaszewski, K. Macromolecules 2006, 39, 39-45.] All other reagents and solvents were used as received from Aldrich. Poly(4-vinylpyridine) (poly(4-VP)) was synthesized by conventional radical polymerization of 4-vinylpyridine in dimethyl formamide (DMF) using azo-bis(2-isobutyronitrile) (AIBN) as the initiator.

Analyses

Molecular weights were determined by size exclusion chromatography (SEC) using THF (flow rate 1 mL/min, 35° C.) as the eluent, with a series of three Styragel columns (10⁵ Å, 10³ Å, 100 Å; Polymer Standard Services) and a Waters 2410 differential refractometer as the detector. Calibration based on polySty standards was used with toluene as the elution volume marker. The polymer solutions were not filtered through columns filled with alumina but only through a 0.2 μm PTFE filter prior to the analysis. IR spectra of the polymers (films cast on NaCl plates from solutions of the polymers in chloroform) were recorded on ATI Mattson Infinity Series FTIR spectrometer. Elemental analyses for C, H, and N of the polymers were determined at Midwest Microlab, IN; the results reported are averaged from two independent composition determinations.

### EXAMPLES

1 A): Synthesis of Polystyrene using a Standard FRP Procedure.

AIBN (0.050 g, 0.30 mmol), styrene (20 mL, 0.175 mol) and toluene (10 mL) were mixed in a 50-mL Schlenk flask equipped with a magnetic stir bar. The flask was capped with a glass stopper and the solution was purged with nitrogen for 1 h. The polymerization was then carried out at 90° C. for 4 h. The contents of the flask were diluted with 20-30 mL of THF and the polymer was precipitated in ca. 1 L of methanol. The polymer was filtered off, washed on the filter with methanol and dried in a vacuum oven at 40° C. Yield: 7.3 g (40%), Mₙ=34,740 g/mol, M_{w}/Mₙ=1.77.

1 B): Azidation of PolySty.

Polystyrene (1.0 g, corresponding to 9.6 mmol of styrene) was dissolved in chlorobenzene (5 mL) and PhI(OAc)₂ (0.5 g, 1.55 mmol) and then the solution was added to a 100 mL two-neck round bottom flask equipped with a magnetic stir bar. One of the flask necks was closed with a rubber septum and the other was attached to a drying tube filled with a mixture of drierite and Na₂CO₃. The heterogeneous mixture was cooled in an ice-water bath, and upon stirring, TMS-N₃ (12.8 mL, 21 mmol) was injected over a period of 1 hour. During the addition of TMS-N₃, evolution of gas was observed. The mixture was stirred in the cooling bath for another 1 hour, by which point the mixture became homogeneous. The rubber septum was then removed and replaced with a reflux condenser, on the top of which was attached a drying tube with drierite and Na₂CO₃. The mixture was heated to 50° C. for 2 hours, during the first 5-10 minutes, an intense evolution of gas was observed. After 2 hours heating the polymer was precipitated in ca. 1 L of methanol, filtered off and washed on the filter with a large amount of methanol to remove any soluble material. The product was then dried and analyzed by SEC: Mₙ=13,980 g/mol, M_{w}/Mₙ=1.90 and IR spectroscopy (ν(N₃)=2107 cm⁻¹).

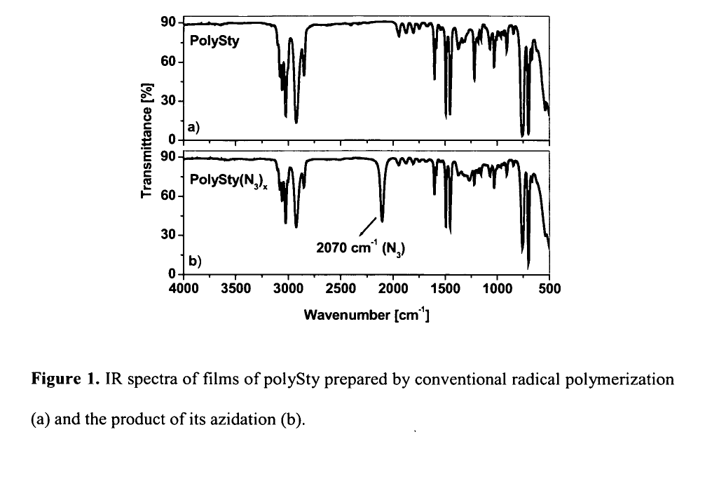

The azidated polymer was analyzed using IR spectroscopy (FIG. 1). An intense signal was observed at 2107 cm⁻¹, corresponding to the asymmetric vibration of the azide group. [Lieber, E.; Rao, C. N. R.; Chao, T. S.; Hoffman, C. W. W. Anal. Chem. 1957, 29, 916-918] Elemental analysis of the azidated polymers (C 89.46, H 7.51, N 3.61) revealed that the degree of azidation was of the order of 10 mole % in the polystyrene prepared by standard free radical polymerization. It should be noted that the sum of the numbers in the elemental analysis equals 100±0.6, indicating the absence of other impurities (trapped solvents, iodobenzene or TMS-compounds) in the polymers.

The concentration of azidating reagents in chlorobenzene is nearly identical to the composition of a polystyrene undecamer capped with H atoms on both chain ends containing one azide group (88.96 wt. % C, 7.47 wt. % H, and 3.58 wt. % N). Therefore, roughly one in 11 units along the backbone of the polymer chain contains an azide group. The molecular weight of this polymer (13,980 g/mol) corresponds to a degree of polymerization of about 130, which means that there are approximately 12 azide groups per chain.

The attached azide groups can be utilized in subsequent functionalization reactions.

1 C: Click Chemistry-type Grafting onto Azidated PolySty.

To further verify that the azide groups were attached to the polymer and the IR signal was not due to trapped TMSN₃, the polymer was reacted with an alkyne group-containing poly(ethylene oxide) under “click” chemistry conditions.

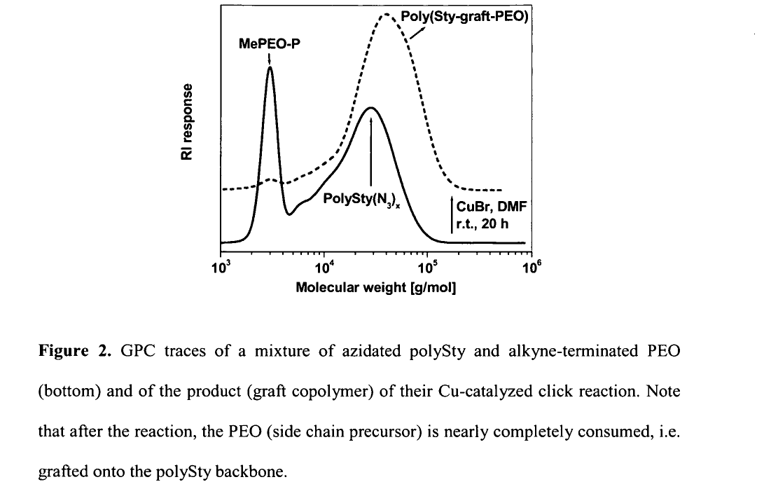

Azidated polystyrene (0.200 g), MePEO-P (0.500 g, 0.5 mmol of acetylene groups), and CuBr (0.0143 g, 0.1 mmol) were added to a reaction vial which was then closed with a rubber septum, and evacuated and back-filled with nitrogen four times. Deoxygenated DMF (2 mL) was added to this mixture, and the yellow-orange solution was stirred at room temperature for 16 h. A small portion of the reaction mixture was diluted with tetrahydrofuran (THF) and analyzed by size exclusion chromatography (SEC) (FIG. 2). For comparison, a mixture was prepared consisting of 0.020 g of azidated polystyrene and 0.050 g of MePEO-P in 0.2 mL of DMF, which was also diluted with THF and analyzed by SEC. The analysis clearly showed that the molecular weight of the polymer after the reaction was higher than that of the starting mixture due to click-type grafting of MePEO-P onto the polystyrene molecules.

Various oxidative coupling reactions of terminal alkynes, including Glaser coupling, are copper-catalyzed, and are documented in the literature. [Siemsen, P.; Livingston, R. C.; Diederich, F. Angew. Chem. Int. Ed. 2000, 39, 2632-2657] When MePEO-P was click grafted onto the azide-rich polymer, the conversion of the side chain precursor was nearly complete. No product of acetylene coupling was observed in this case, which may be attributed to faster click coupling with the azide groups from the backbone precursor than oxidative homo-coupling of MePEO-P. The peak molecular weight in this case increased from Mₚ=28,700 g/mol (azidated polySty with Mₙ=13,980 g/mol to Mₚ=39,500 g/mol for the polymeric brush. In this case the relative increase of the Mₚ value of the copolymer was about 38%.

This result clearly demonstrates that the azide groups were attached chemically to the polystyrene; that the azidation reaction was efficient, and further that the attached azide groups could be employed in a second functionalization reaction.

This example exemplifies the concept that the direct azidation of polymers is an attractive method of preparation of numerous functional materials, on one hand—due to the ease of the reaction (no special monomers need to be synthesized), and on the other—due to the very rich chemistry of azides, which is not limited to click chemistry cycloadditions, but includes reduction to amines, thermal or photodegradation to reactive nitrenes, etc.

### EXAMPLE 2

### Azidation of Polystyrene Prepared by a Controlled Radical Polymerization Process

2A: The polystyrene sample, (Mₙ=1,600 g/mol, M_{w}/Mₙ=1.1) was prepared by ARGET ATRP. [Jakubowski, W.; Min, K.; Matyjaszewski, K. Macromolecules 2006, 39, 39-45.] In addition to the narrow M_{w}/Mₙ this sample of polystyrene has a terminal halogen that can also participate in the azidation reaction and subsequent reactions.

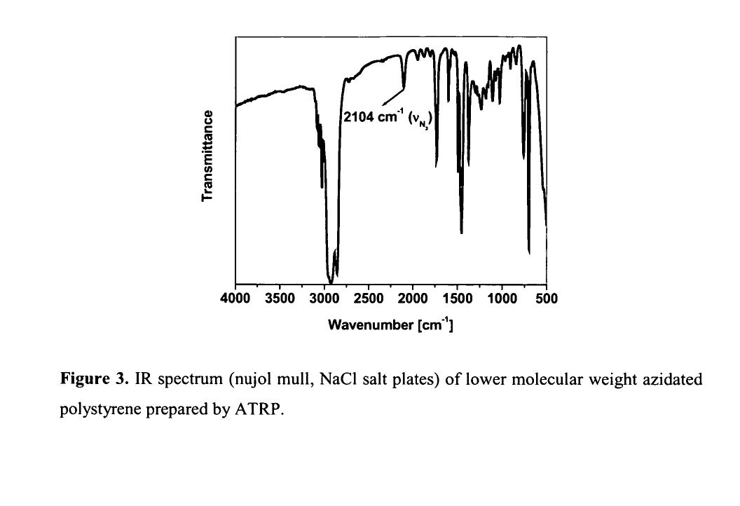

2B; Narrow polydispersity polystyrene (1.0 g, corresponding to 9.6 mmol of styrene) was dissolved in 1,2-dichloroethane (5 mL) and PhI(OAc)₂ (0.25 g, 0.776 mmol) was added. The solution was cooled in ice and purged with nitrogen for 20 min. Then, the reaction flask was removed from the ice bath, and TMSN₃ (0.278 mL, 1.55 mmol) was slowly added over a period of 1 hour. The mixture was stirred for 2 hours at room temperature, and then at 50° C. for 1 hour. The modified polymer was precipitated in methanol, filtered, washed with several 300-mL portions of methanol, and dried. IR analysis (FIG. 3) revealed that the polymer contained azide groups.

To verify that the azide groups were attached to the polymer and the IR signal was not due to trapped TMSN₃, the polymer was reacted with an alkyne group-containing poly(ethylene oxide) under “click” chemistry conditions.

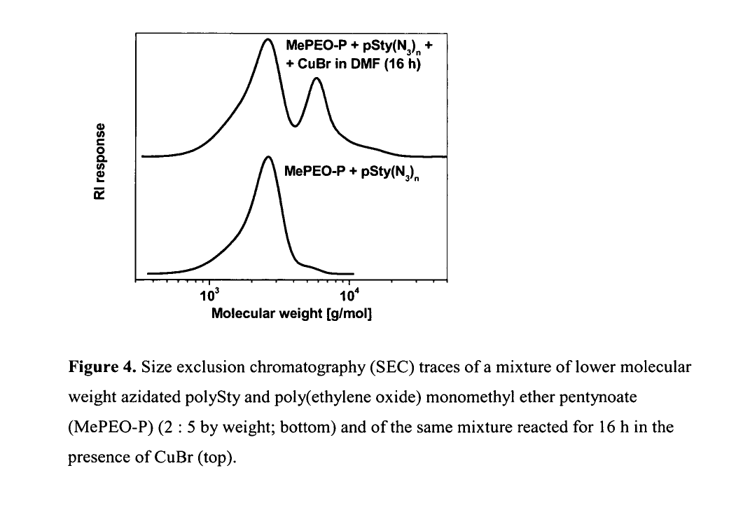

2C: Azidated polystyrene (0.200 g), MePEO-P (0.500 g, 0.5 mmol of acetylene groups), and CuBr (0.0143 g, 0.1 mmol) were added to a reaction vial which was then closed with a rubber septum, and evacuated and back-filled with nitrogen four times. Deoxygenated DMF (2 mL) was added to this mixture, and the yellow-orange solution was stirred at room temperature for 16 h. A small portion of the reaction mixture was diluted with tetrahydrofuran (THF) and analyzed by size exclusion chromatography (SEC) (FIG. 4).

For comparison, a mixture was prepared consisting of 0.020 g of azidated polystyrene and 0.050 g of MePEO-P in 0.2 mL of DMF, which was also diluted with THF and analyzed by SEC. The analysis clearly showed that the molecular weight of the polymer after the reaction was higher than that of the starting mixture due to click-type grafting of MePEO-P onto the polystyrene molecules.

This result clearly demonstrates that the azide groups were attached chemically to the polystyrene and that the azidation reaction was efficient and further that the attached azide groups could be employed in a second functionalization reaction, including but not limited to formation of a graft copolymer.

### EXAMPLE 3

### Azidation of Poly(4-Vinyl Pyridine)

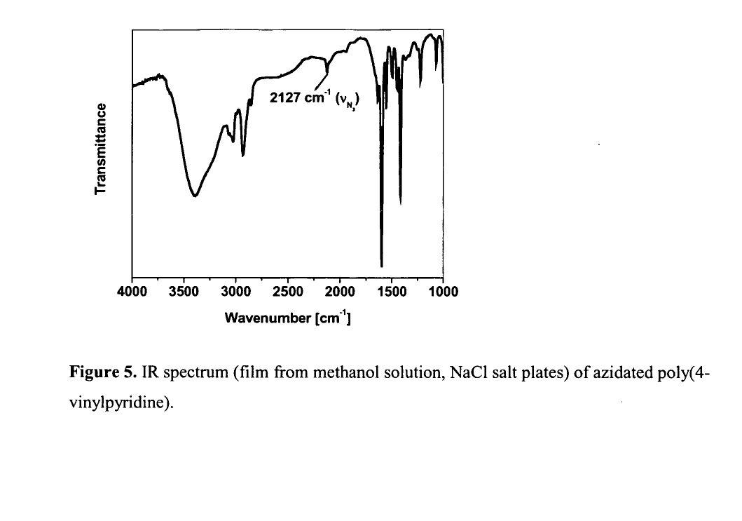

Poly(4-vinylpyridine) was synthesized by conventional radical polymerization of 4-vinylpyridine in DMF using azo-bis(2-isobutyronitrile) (AIBN) as the initiator. Poly(4-vinyl pyridine) (1.05 g, corresponding to 10 mmol of 4-vinyl pyridine units) was dissolved in chloroform (25 mL) and PhI(OAc)₂ (1.611 g, 5 mmol) was added. The mixture was stirred until a clear solution was formed. Then, the reaction flask was cooled in ice-water bath, and TMSN₃ (1.33 mL, 10 mmol) was added slowly, over a period of 1 hour. The mixture was stirred for 1 hour in the cooling bath, and then at 60° C. for 1 hour. The modified polymer was precipitated in ether, filtered, washed with ether, and dried. IR analysis (FIG. 5) revealed that the polymer contained azide groups.

This example indicates that the disclosed procedure can be applied to multiple functional polymers to incorporate further functionality.

1. A process for the functionalization of polymers comprising a radically abstractable proton or unsaturation, wherein the functionalization reaction is an azidation, cyanation, thiocyanation, amination reaction.

2. The process of claim 1, wherein the functionalization comprises reaction of a compound comprising a hypervalent iodine group with the first polymer.

3. The process of claim 2, wherein hypervalent iodine additionally comprises an azide, cyano, thiocyano or amino group.

4. The process of claim 1, wherein the attached azide functionality is attached to the polymer through stable carbon-carbon bonds.

5. The process of claim 1, wherein the attached azide functionality is converted into a second tethered functionality.

6. The process of claim 1, wherein the first polymer is in the solid state and the surface of the polymer is functionalized.

7. A process for functionalization of a surface by deposition of a polymer comprising azido-functional groups on the surface and the stimulated decomposition of the azido-groups tethers the deposited polymer to the surface.

8. A process for functionalization of a surface by deposition of the polymer of claim 5 on a surface and the second functionality present in the deposited polymer tethers the deposited polymer to the surface.
